(19) United States
(12) Patent Application Publication
(10) Pub. No.: US 2013/0252044 A1
(43) Pub. Date: Sep. 26, 2013

(54) Electrode for High Performance Metal Halogen Flow Battery

(71) Applicant: PRIMUS POWER CORPORATION, HAYWARD, CA (US)

(72) Inventors: Mai Fujimoto, Hayward, CA (US); Brad Kell, Pembroke, MA (US); Gerardo Jose la O', Alameda, CA (US); Jonathan Hall, San Mateo, CA (US); Lauren Wessel Hart, San Francisco, CA (US); Pallavi Pharkya, Fremont, CA (US); Paul Kreiner, San Francisco, CA (US); Kyle Haynes, Redwood City, CA (US)

(73) Assignee: PRIMUS POWER CORPORATION, HAYWARD, CA (US)

(21) Appl. No.: 13/850,378

(22) Filed: Mar. 26, 2013

Related U.S. Application Data
(60) Provisional application No. 61/615,544, filed on Mar. 26, 2012.

(51) Int. Cl. H01M 10/36; H01M 10/38

(52) U.S. Cl. CPC H01M 10/365; H01M 10/38
USPC 429/80; 429/209; 429/218.1; 429/231.5; 429/156; 29/623.1; 427/58; 427/126.3; 427/126.5

(57) ABSTRACT

A porous electrode for a flow battery includes a first layer having a first average pore size and a second layer having a second average pore size, wherein the second pore size is smaller than the first pore size.

### CROSS-REFERENCE TO RELATED PATENT APPLICATION

The present application claims benefit of priority of U.S. Provisional Patent Application No. 61/615,544, filed on Mar. 26, 2012 which is incorporated herein by reference in its entirety.

This invention was made with Government support under contract DE-AR0000143 awarded by Department of Energy. The Government has certain rights in the invention.

### FIELD

The present invention is generally directed to flow batteries and more specifically to electrodes for flow batteries.

### BACKGROUND

The development of renewable energy sources has revitalized the need for large-scale batteries for off-peak energy storage. The requirements for such an application differ from those of other types of rechargeable batteries such as lead-acid batteries. Batteries for off-peak energy storage in the power grid generally are required to be of low capital cost, long cycle life, high efficiency, and low maintenance.

One type of electrochemical energy system suitable for such an energy storage is a so-called “flow battery” which uses a halogen component for reduction at a normally positive electrode, and an oxidizable metal adapted to become oxidized at a normally negative electrode during the normal operation of the electrochemical system. An aqueous metal halide electrolyte is used to replenish the supply of halogen component as it becomes reduced at the positive electrode. The electrolyte is circulated between the electrode area and a reservoir area. One example of such a system uses zinc as the metal and chlorine as the halogen.

Such electrochemical energy systems are described in, for example, U.S. Pat. Nos. 3,713,888, 3,993,502, 4,001,036, 4,072,540, 4,146,680, and 4,414,292, and in EPRI Report EM-I051 (Parts 1-3) dated April 1979, published by the Electric Power Research Institute, the disclosures of which are hereby incorporated by reference in their entirety.

### SUMMARY

An embodiment relates to a porous electrode for a flow battery which includes a first layer having a first average pore size and a second layer having a second average pore size, wherein the second pore size is smaller than the first pore size.

Another embodiment relates to a method of making a porous electrode for a flow battery, comprising forming a first layer from powder particles having a first mesh size and forming a second layer from powder particles having a second mesh size smaller than the first mesh size.

Another embodiment relates to a flow battery, comprising a stack of flow battery cells, wherein each cell comprises a positive electrode and a negative electrode spaced apart from the positive electrode by a reaction zone, and an electrically insulating porous restriction layer located in an electrolyte flow channel between the positive electrode of one cell and negative electrode of an adjacent flow cell in the stack.

Another embodiment relates to a method of making a flow battery electrode assembly, comprising forming green junction ribs and a green sealing rim on a surface of a porous electrode, sintering the green junction ribs and the rim, and attaching the sintered junction ribs to a non-porous electrode to form the electrode assembly.

### BRIEF DESCRIPTION OF THE DRAWINGS

FIG. 1 is a schematic side cross sectional view illustration of a multi-porous electrode according to an embodiment.

FIG. 2 is a schematic side cross sectional view illustration of another multi-porous electrode according to an embodiment.

FIG. 3A is a perspective view of a multi-porous electrode with junction ribs and a sealing rim according to an embodiment. FIG. 3B is a close up of the multi-porous electrode of FIG. 3A. FIG. 3C is a close up of FIG. 3B. FIG. 3D is a micrograph illustrating the microstructure of a cross section of the multi-porous electrode of FIG. 3A.

FIGS. 4A and 4B are alternative schematic side cross sectional view illustrations of a cell with a restriction layer according to an embodiment.

FIG. 5 is a schematic side cross sectional view illustration of six electrode configurations used in an computational fluid dynamics simulation.

FIG. 6 is a plot illustrating results comparing electrolyte velocity in electrodes with and without an additional restriction layer.

FIG. 7 is a plot illustrating results comparing electrolyte velocity in electrodes having baffle configurations with a configuration lacking a gap.

FIG. 8 is a plot illustrating average pore size of multi-layer electrodes according to embodiments.

FIG. 9 is a plot illustrating surface area of multi-layer electrodes according to embodiments.

FIG. 10A is a micrograph illustrating the microstructure of porous electrodes with a mesh-325 monolayer. FIG. 10B is a micrograph illustrating the microstructure of porous electrodes with a mesh-325 and mesh-100 bilayer.

FIG. 11 is a simulation showing flow velocity with and without restriction layer through an electrode according to an embodiment.

FIG. 12A is a plot showing the effect of a restriction layer on flow velocity. FIG. 12B is a plot showing the effect of a restriction layer and a gap on flow velocity.

FIG. 13 is a plot illustrating electrochemical polarization curves at different charge and discharge current densities obtained with the porous electrodes made from different mesh sizes material.

### DETAILED DESCRIPTION

Embodiments include a multilayer positive electrode structure for a metal halogen flow cell. The multilayer electrode structure provides one or more of the following advantages over conventional positive electrodes: a more uniform fluid flow and pressure distribution, high electrochemical reaction kinetics, high mechanical integrity, excellent manufacturing tolerance as well as lower cost. An embodiment is drawn to an electrode that is permeable to the electrolyte and fabricated by sintering metal oxides. The metal oxides can be, but are not limited to, titanium oxide, tantalum oxide, tungsten oxide and oxides of other refractory metals.

In a first embodiment, the positive electrode is produced by sintering metal powders or metal oxide powders such as titanium, tantalum, titanium oxide, tantalum oxide, tungsten oxide or combinations thereof. The sintered powder becomes a porous structure with high surface area, uniform thickness and desired pore size and permeability.

Typically, finer particles are more expensive to make than coarser particles. Thus, to save cost, electrodes made by powder metallurgy are typically fabricated with coarser particles. However, fabrication with smaller particles yields an electrode with increased surface area which produces superior electrochemical performance in the battery. By fabricating a multi-layer electrode having a layer made of coarser particles and a layer of finer particles, an electrode with the superior electrochemical performance of the finer particles can be achieved at less cost than an electrode made entirely from finer particles.

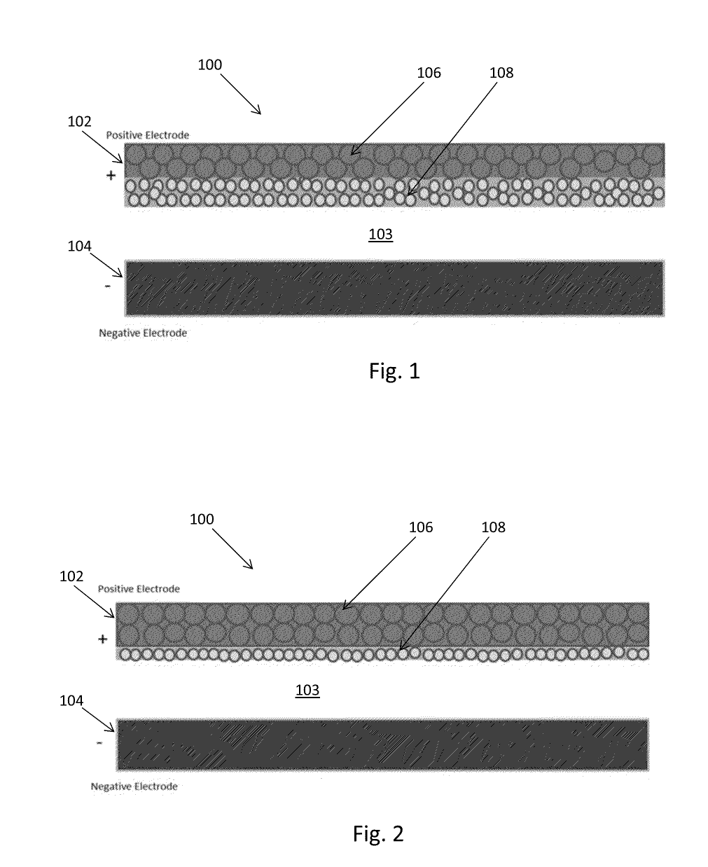

FIGS. 1 and 2 illustrate embodiments of an electrochemical cell 100, such as a flow cell of a flow battery, having a multi-porous electrode 102. In the embodiment illustrated in FIG. 1, the multi-porous electrode 102 is a bi-layer electrode. The bilayer multi-porous electrode 102 includes two layers 106, 108 that are made from powders of different mesh size. For example, a powder that is designated as “325 mesh” passed though a 325 mesh screen and the powder's particle size (i.e., the maximum particle diameter) is less than 44 microns. That is, the bilayer multi-porous electrode 102 includes a first, coarse layer 106 that is made from coarser particles of a larger mesh size and a second, fine layer 108 made from finer particles with a smaller mesh size than that of the coarse layer 106.

Preferably, when using the bilayer multi-porous electrode 102 in a flow battery, the finer particle side of the (positive) electrode 102 is placed facing the reaction zone 103 and the negative electrode 104 of the electrochemical cell 100 to take advantage of the higher surface area of the fine layer 108 during the electrochemical reaction in the flow battery. In a metal halide flow battery, the metal (e.g., zinc) is plated onto the surface of the negative electrode 104 facing the reaction zone 103.

The electrode 102 may be made by separately sintering powders to form layers 106, 108 and then joining the layers 106, 108 to form the electrode. Alternatively, green layers 106, 108 or packed powder layer 106, 108 may be placed in contact with each other followed by a single common sintering step to form electrode 102. Alternatively, one layer (e.g., layer 106) is formed and sintered first, followed by forming the other green layer (e.g., layer 106) on the sintered layer (e.g., 108), followed by a second sintering step.

FIG. 2 illustrates an alternative embodiment of the multi-porous electrode 102. In this embodiment, the fine layer 108 includes a layer of metal powder that is sprayed on one side (e.g., the reaction zone 103 facing side) of the coarse layer 106. Any spraying, such as plasma-arc spray, shrouded plasma-arc spray, high velocity, oxy-fuel (HVOF), electric arc-spray, flame spray, or cold spray, may be used. Layer 108 may be sprayed onto a sintered layer 106 followed by a second sintering step or layer 108 may be sprayed onto layer 106 which comprises a green precursor or packed powder followed by a single common sintering step. Layer 108 may be formed by spraying either a sintered or unsintered powder or a green precursor onto layer 106. A post spraying sintering step is optional.

The fine layer 108 may include, but is not limited to, particles, of fine titanium. The coarse layer 106 may also include, but is not limited to sintered titanium powder. As with the first embodiment, the fine particle layer 108 of the electrode 102 is preferably placed facing the negative electrode 104 in a flow battery cell to take advantage of the higher surface area of the fine particles during the electrochemical reaction in the flow battery. In this embodiment, the fine powdered titanium layer 108 provides a region for high electrochemical activity, while layer with bigger metal powder mesh 106 provides structural integrity. The use of a coarser mesh size titanium powder for mechanical integrity also assists in lowering the cost.

In another alternative embodiment, the multi-porous electrodes 102 are made with multilayer wire meshes (e.g., stacked or joined fine and coarse wire meshes). A wire mesh provides more surface area than a solid plate. Fine or coarse meshes in this embodiment could be, but are not limited to be, manufactured from titanium, tantalum or tungsten wire, or an aluminum wire coated with a thin layer of titanium, tantalum or tungsten deposited by techniques such as electroplating, physical vapor deposition or chemical vapor deposition.

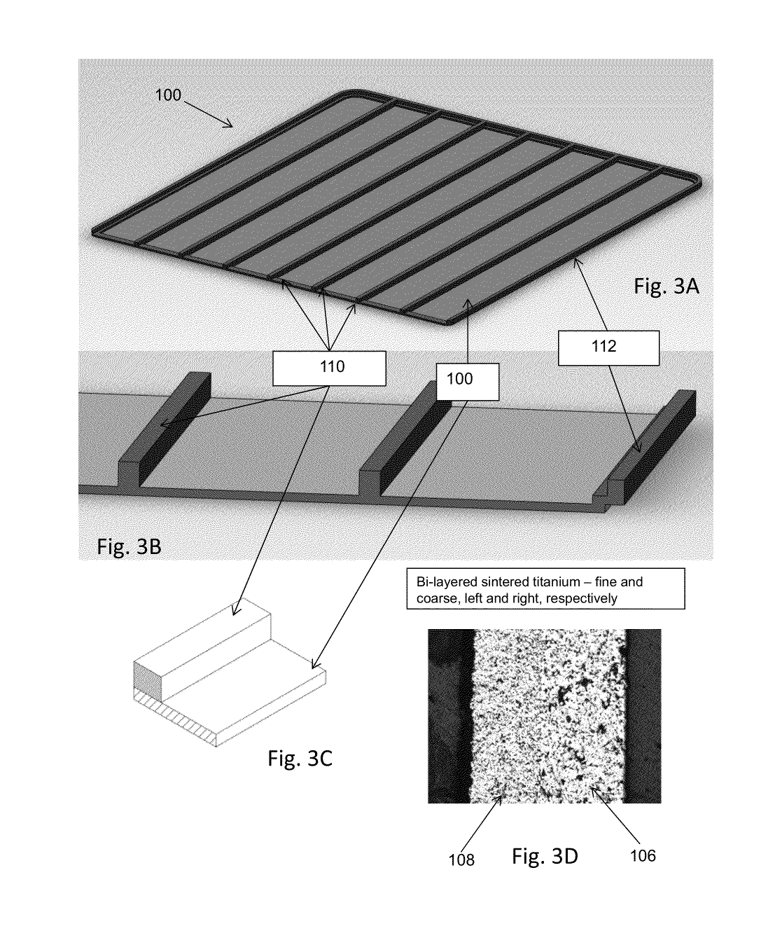

FIGS. 3A-3D illustrate a multi-porous electrode 102 with junction ribs 110 and a sealing rim 112 according to a second embodiment. This design illustrates an economical method of integrating the multi-porous electrode 102 with similarly fabricated junction ribs 110 and/or a sealing rim 112. The performance of the multi-porous electrode 102 is sensitive to the size of mesh used during the sintering process. Using smaller meshes with a tight tolerance on the particle size is more costly than using larger meshes with looser tolerances. In this embodiment, particles larger mesh sizes are used to produce the sealing rim 112 and the junction ribs 110. The ribs 110 connect the postive/porous electrode 102 of one cell with a negative electrode 104 of an adjacent cell in the stack of cells to form an electrode assembly. Electrolyte flow channels are located between adjacent ribs on the side of the positive electrode 102 facing away from the reaction zone 103.

In an embodiment of a method of making the multi-porous electrode 102 illustrated in FIG. 3A, an electrode portion 100 is produced in a “green” pre-sintered state from powder of desired mesh(es) (e.g., the fine and coarse layers described above). Separately, the sealing rim 112 and junction ribs 110 are formed in a green state from a coarse mesh powder. Then, the green sealing rim 112 and junction ribs 110 are provided in contact with the multi-porous electrode 102. The entire green assembly is then sintered. Optionally, the coarsness and final density tolerance of the sealing rim 112 and junction ribs 110 may be selected to meet stiffness and weldability requirements.

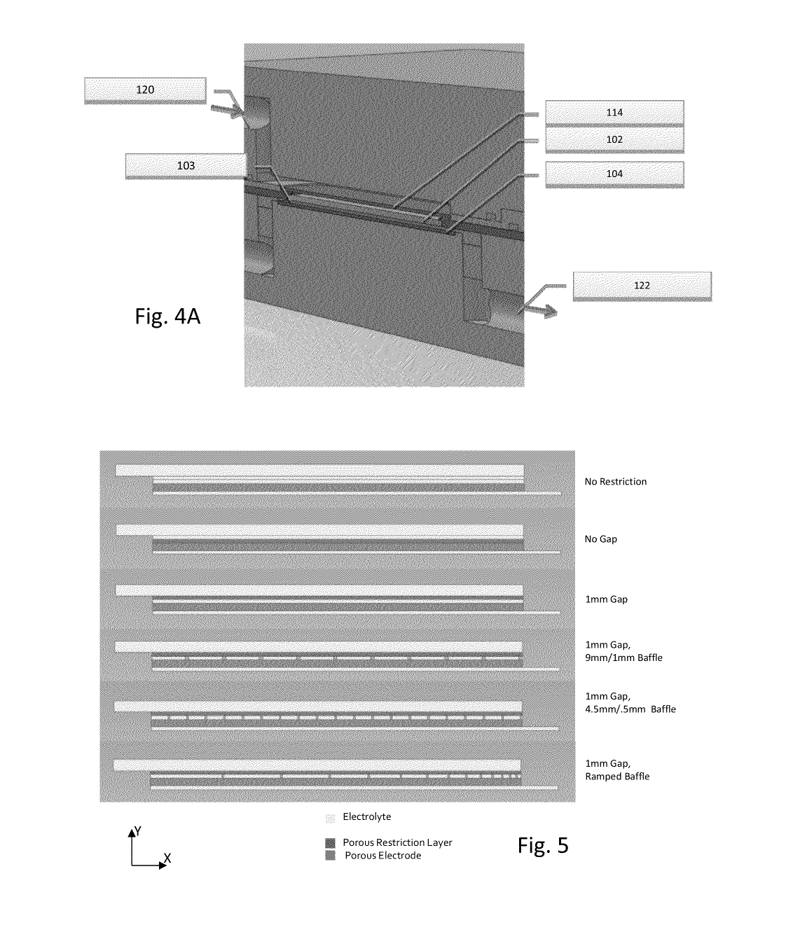

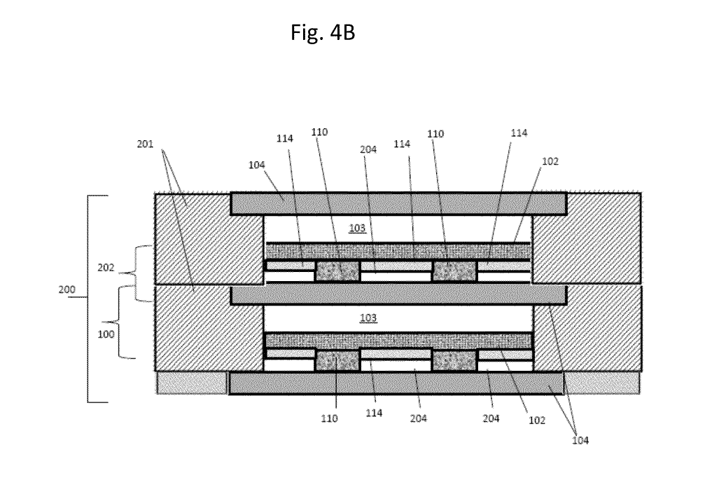

In a third embodiment illustrated in FIGS. 4A and 4B, the electrochemical cell 100 may include a non-conductive porous flow restriction layer 114. The non-conductive porous layer 114 acts as a flow restrictor, improving the uniformity of fluid flow within the porous electrode 102. The cell 100 may be oriented with the porous electrode 102 above the reaction zone 103 as shown in FIG. 4A or with the non-porous electrode located above the reaction zone as shown in FIG. 4B.

FIG. 4B shows a side cross sectional view of a stack 200 of cells 100 supported by a frame 201. Each cell 100 includes the porous 102 and non-porous 104 electrodes separated by a reaction zone 103. A porous electrode 102 of one cell is connected to the non-porous electrode 104 of an adjacent cell by the ribs 110 to form an electrode assembly 202. Electrolyte flow channels 204 are located between the ribs 110 in each electrode assembly 202. Each flow channel 204 is bounded by two ribs (or a rib and a frame 201) on the sides, the flow restriction layer 114 on top (or on the bottom if the stack 200 is flipped upside down as shown in FIG. 4A), and surface of the non-porous electrode 104 facing away from the reaction zone 103 on the bottom (or on top in FIG. 4A configuration). The stack 200 may be located in a flow battery system containing a housing, an electrolyte (e.g., zinc-bromide or zinc-chloride) reservoir and an electrolyte pump.

In an embodiment, the non-conductive porous restriction layer 114 may be affixed to the porous electrode 102 (e.g., the multi-porous electrode of the above embodiments or another porous electrode having a single porosity and/or made by other suitable methods that those described above), as shown in FIG. 4B. Alternatively, the restriction layer 114 may be spaced apart from the porous electrode 102 and be held in place by the frame 200 and/or the ribs 110, as shown in FIG. 4A.

Alternatively, the stack may include an optional alignment part (e.g. molded plastic) that presses the restriction layer 114 against the porous electrode 102. The restriction layer 114 may be co-molded, welded, or otherwise integrated with this alignment part. The restriction layer(s) and corresponding alignment part(s) may be installed during the fabrication of the bipolar electrode assembly 202, such that they are captive, or installed after the bipolar electrode assembly 202 is fabricated such that they are removable.

Layer 114 may comprise layer having slit shaped openings (e.g., cut-outs) such that the ribs 110 protrude through the openings, as shown in FIG. 4B. Alternatively, layer 114 may comprise plural discrete strips which are placed or wedged between the ribs 110 in the flow channels 204. The non-conductive porous restriction layer 114 may be a porous sintered plastic, a plastic felt, a porous ceramic, or a variety of other electrically insulating materials.

As shown in FIG. 4A, electrolyte enters the electrochemical cell 100 via the inlet 120 between adjacent cells in the flow battery stack and spreads through flow channels 204 (shown in FIG. 4B) across the non-conductive porous layer 114 before passing to the porous electrode 102, thereby evening the flow to the porous electrode 102 below. After passing through the porous electrode 102, the electrolyte flows through the reaction zone 103 and exits the electrochemical cell 100 via an outlet 122. Alternatively, the electrolyte enters the cell 100 through the reaction zone 103, and then at least a portion of the electrolyte flows through the porous electrode 102 and out of the cell through the flow channels 204. Advantageously, the non-conductive porous layer 114 may be made of a less expensive material than the porous electrode 102. Optionally, a baffle type structure (junction ribs 110 or additional electrically insulating baffles located between spaced apart layer 114 and electrode 102) may also be used to improve the fluid flow distribution.

Using computational fluid dynamics (CFD), the potential impact of a separate porous restriction layer 114, the effect of any gap between the restriction layer 114 and the porous electrode 102 and the effect of an additional baffle structure in the gap were analyzed. FIG. 5 shows several configurations were modeled in a 2-D CFD study. Configurations modeled include: (1) no non-conductive porous layer 114, (2) a non-conductive porous layer 114 located immediately adjacent the porous electrode 102 (no gap), (3) a non-conductive porous layer 114 located with a 1 mm gap between the non-conductive porous layer 114 and the porous electrode 102, (4) a non-conductive porous layer 114 located with a 1 mm gap between the non-conductive porous layer 114 and the porous electrode 102 and a baffle structure of 1 mm wide junction ribs 110 (or additional insulating baffles) separated 9 mm apart, (5) a non-conductive porous layer 114 located with a 1 mm gap between the non-conductive porous layer 114 and the porous electrode 102 and a baffle structure of 0.5 mm wide junction ribs 110 (or additional insulating baffles) separated 4.5 mm apart and (6) a non-conductive porous layer 114 located with a 1 mm gap between the non-conductive porous layer 114 and the porous electrode 102 and a baffle structure of junction ribs 110 (or additional insulating baffles) with varying separation distance (e.g., decreasing in electrolyte flow direction) between adjacent junction ribs.

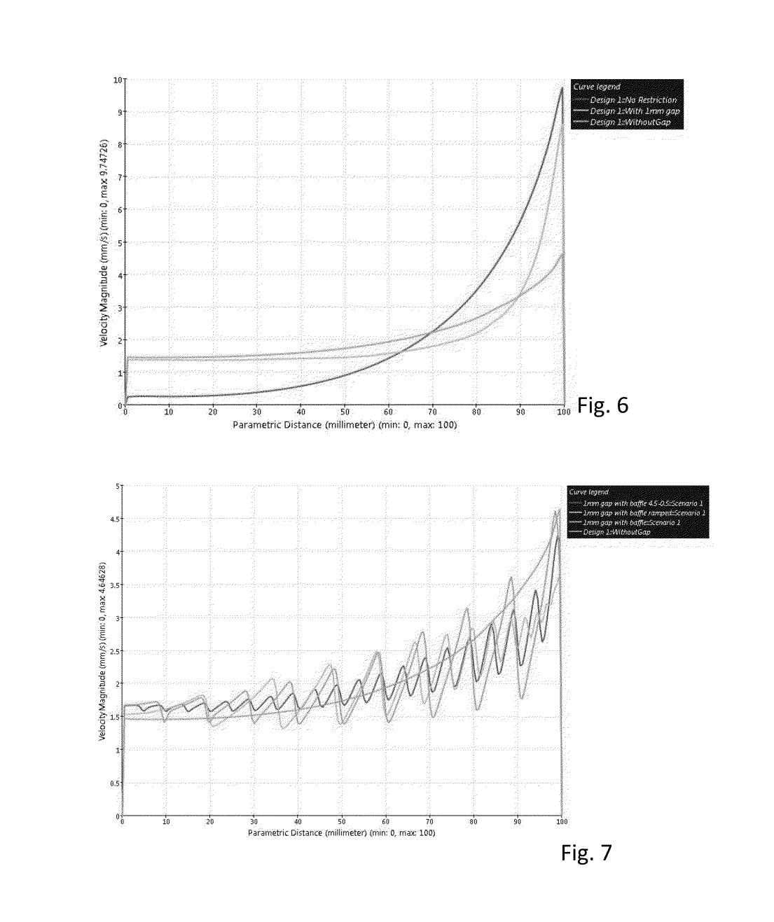

The results of the CFD simulations are illustrated in FIGS. 6 and 7. FIG. 6 compares the electrolyte velocity in the porous electrode 102 with and without an additional non-conductive porous restriction layer 114 (with and without a gap between electrode 102 and layer 114). FIG. 7 compares the electrolyte velocity in the device having the restriction layer 114 separated from the porous electrode 102 with baffle structures (e.g., junction ribs 110) to the configuration with no gap between layer 114 and electrode 102). The results of the CFD studies suggest that the “no gap” configuration (the porous restriction layer bonded to the porous electrode) appear effective at evening the fluid flow, as shown in FIG. 6. A configuration including a gap between the non-conductive porous restriction layer 114 and the porous electrode 102 showed an improvement in electrolyte velocity distribution at the inlet 120, but showed little impact at the outlet 122. Each of the “baffle” configurations in FIG. 7 provided a similar improvement as the configuration in which layer 114 contacts the electrode 104.

Another embodiment is drawn to an electrode assembly which includes a porous electrode 102 affixed to an impermeable electrode 102. The electrodes may be affixed by any suitable method, such as welding or brazing. Example electrode assemblies are described in U.S. patent application Ser. No. 12/877,884, filed Sep. 8, 2010, hereby incorporated in its entirety.

### Test Results

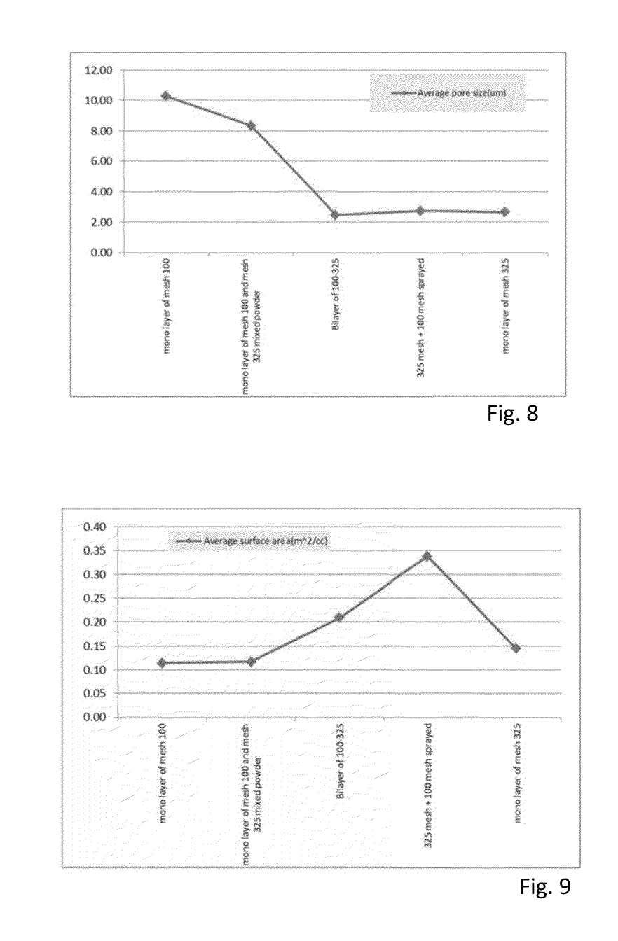

The average pore size and surface area data for five porous electrodes 102 made of various powder sizes and assemblies are presented for comparison: (1) mono-layer made from mesh-100 powder, (2) mono-layer made from mesh-100 and -325 mixed powders, (3) bilayer made from mesh-100 and mesh-325 powders, (4) bilayer made from coarse layer made from mesh-100 powder and sprayed on mesh-325 fine layer and (5) monolayer made from mesh-325. The pore size and surface area were measured by the capillary flow porosimetry technique. FIG. 8 illustrates the average pore sizes of these electrodes. As can be seen in FIG. 8, the average pore size of the multi-layer electrodes (3), (4) is as small as the monolayer (5) of fine mesh particles. FIG. 9 illustrates the average surface area of the electrodes. The average surface area of multilayer electrodes (3), (4) is higher than any of the monolayer electrodes (1), (2), (5).

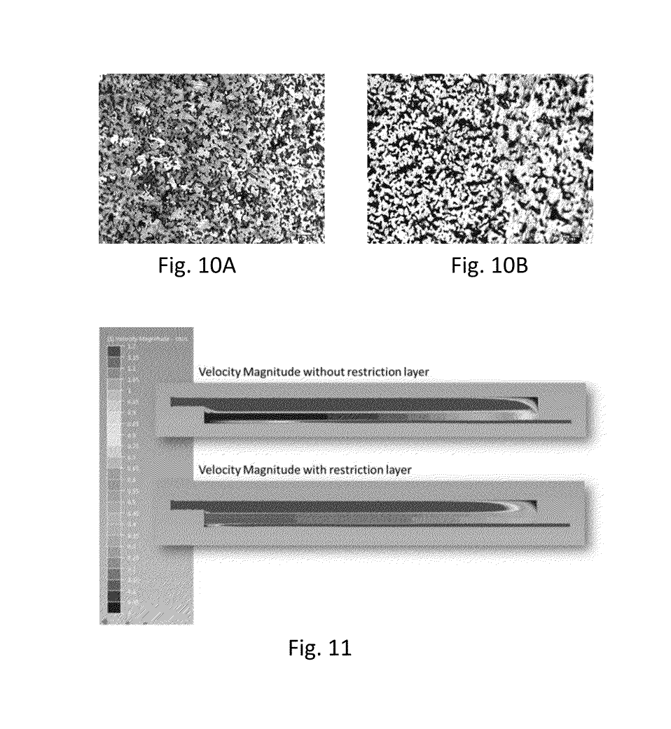

FIGS. 10A and 10B are micrographs illustrating the microstructure of a comparative monolayer electrode and a bilayer multi-porous electrode, respectively. FIG. 10A illustrates the microstructure of a single layer porous electrode made from a mesh-325, while FIG. 10B illustrates the microstructure of a bilayer multi-porous electrode made from a mesh-325 layer and a mesh-100 powder. In FIG. 10B, the coarse mesh-100 microstructure is on the right side and the fine mesh-325 microstructure is on the left side.

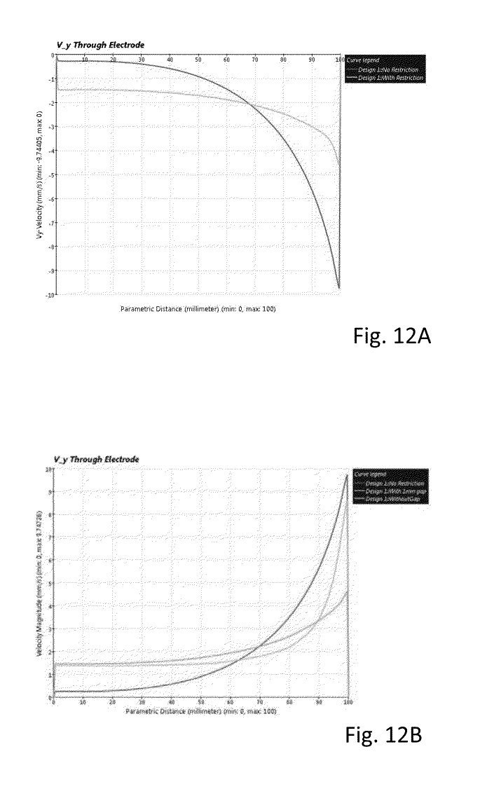

FIG. 11 is a simulation illustrating the fluid velocity through a porous electrode with and without a porous restriction layer 114 of the third embodiment. As can be seen in the lower simulation, the restriction layer provides much uniform flow velocity. FIG. 12A is a plot of the velocity through the electrode as a function of normalized distance (0-100%) along the electrode. FIG. 12A clearly shows that the addition of a porous restriction layer provides a more uniform flow velocity. FIG. 12B illsutrates effect of using a porous restriction layer in combination with a gap on the flow velocity distribution. As can been seen in FIG. 12B, the addition of the gap decreases the uniformity of the velocity distribution relative to the use of a restriction layer without a gap. However, the use of a restriction layer and a gap provides a more uniform velocity distribution than not using a restriction layer.

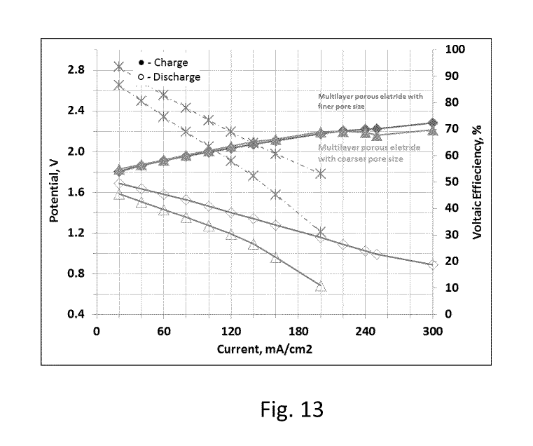

FIG. 13 below presents the electrochemical polarization curves at different charge and discharge current densities obtained with the porous electrodes made from different mesh sizes material. As can be seen FIG. 13, the electrode with the finer size shows lower overpotential for charge and much lower overpotentials for discharge current. The finer mesh size porous electrode has a much higher surface area. Thus, the finer mesh size porous electrode has a significantly higher electrochemical activity and superior voltaic efficiency for a given current density.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. A porous electrode for a flow battery comprising a first layer having a first average pore size and a second layer having a second average pore size, wherein the second pore size is smaller than the first pore size.

2. The electrode of claim 1, wherein the first layer comprises a sintered first powder having a first average particle size and the second layer comprises a sintered second powder having a second average particle size smaller than the first average particle size.

3. The electrode of claim 1, wherein:
the first powder comprises titanium metal, titanium oxide, tantalum oxide, tungsten oxide, ruthenium oxide or combinations thereof; and
the second powder comprises titanium metal, titanium oxide, tantalum oxide, tungsten oxide or ruthenium oxide or combinations thereof.

4. The electrode of claim 2, wherein the second layer is coated on the first layer.

5. The electrode of claim 2, further comprising one or junction ribs and/or a sealing rim.

6. The electrode of claim 5, wherein the junction ribs and the sealing rim comprises a sintered powder having a particle size larger than the second average size.

7. The electrode of claim 5, wherein the junction ribs and the sealing rim comprise a sintered powder having an average particle size substantially the same as first average particle size.

8. The electrode of claim 5, wherein the junction ribs and the sealing rim comprises the same material composition as the first or second layers of the electrode.

9. The electrode of claim 1, wherein the first layer comprises a first metal wire mesh and the second layer comprises a second metal wire mesh, wherein the second metal wire mesh is finer than the first metal wire mesh.

10. A metal halogen flow cell comprising a positive electrode comprising the electrode of claim 1 and a negative electrode, wherein the second layer faces the negative electrode and a reaction zone of the flow cell.

11. The metal halogen flow cell of claim 10, further comprising an electrically insulating porous restriction layer located between the positive electrode and negative electrode of an adjacent flow cell.

12. The metal halogen flow cell of claim 11, wherein the restriction layer is located in contact with the positive electrode.

13. The metal halogen flow cell of claim 11, the flow cell comprises a gap between the restriction layer and the positive electrode.

14. The metal halogen flow cell of claim 13, wherein the positive electrode further comprises junction ribs located in the gap between the restriction layer and the positive electrode.

15. The metal halogen flow cell of claim 14, wherein the junction ribs are evenly spaced apart or are configured to form a ramped baffle.

16. An electrochemical flow battery comprising a plurality of flow cells of claim 10, an electrolyte reservoir and an electrolyte pump.

17. A method of making a porous electrode for a flow battery comprising forming a first layer from powder particles having a first mesh size and forming a second layer from powder particles having a second mesh size smaller than the first mesh size.

18. The method of claim 17, wherein the first layer and the second layer comprise the same material, and the second layer has a second average pore size smaller than a first average pore size of the first layer.

19. The method of claim 18, wherein forming a first layer having a first average pore size comprises sintering a first powder having a first average particle size and forming a second layer having a second average pore size comprises sintering a second powder having a second average particle size.

20. The method of claim 18, wherein forming the first layer having a first average pore size comprises sintering a first powder having a first average particle size and forming the second layer having a second average pore size comprises spraying a second powder on the first metal oxide powder before or after sintering the first powder.

21. The method of claim 17, wherein:
the first layer comprises titanium, titanium oxide, tantalum oxide, tungsten oxide, ruthenium oxide or combinations thereof; and
the second layer comprises titanium, titanium oxide, tantalum oxide, tungsten oxide, ruthenium oxide or combinations thereof.

22. The method of claim 17, further comprising forming green junction ribs and a green sealing rim on a surface of the porous electrode and sintering the green junction ribs and rim.

23. A method of making an electrochemical flow cell, comprising:
providing a positive electrode made by the method of claim 17;
providing a negative electrode spaced apart from the positive electrode by a reaction zone, such that the positive electrode so that the second layer faces the negative electrode and the reaction zone.

24. The method of claim 22, further comprising providing an insulating porous restriction layer located between the positive electrode and a negative electrode of an adjacent flow cell.

25. A flow battery, comprising:
a stack of flow battery cells, wherein each cell comprises a positive electrode and a negative electrode spaced apart from the positive electrode by a reaction zone; and
an electrically insulating porous restriction layer located in an electrolyte flow channel between the positive electrode of one cell and negative electrode of an adjacent flow cell in the stack.

26. A method of making a flow battery electrode assembly, comprising:
forming green junction ribs and a green sealing rim on a surface of a porous electrode;
sintering the green junction ribs and the rim; and
attaching the sintered junction ribs to a non-porous electrode to form the electrode assembly.
